(19) United States
(12) Patent Application Publication
(10) Pub. No.: US 2004/0058217 A1
(43) Pub. Date: Mar. 25, 2004

(54) Fuel cell systems having internal multistream laminar flow

(76) Inventors: Leroy J. Ohlsen, Gold Bar, WA (US); Jonathan C. Mallari, Seattle, WA (US)

Correspondence Address: THOMAS E. LOOP, BARNARD, LOOP & MCCORMACK, 947 POWELL AVENUE SW, SUITE 105, RENTON, WA, 98055, US

(21) Appl. No.: 10/251,518

(22) Filed: Sep. 20, 2002

(51) Int. Cl. H01M 4/86; H01M 8/08

(52) U.S. Cl. 429/34; 429/46; 429/40

(57) ABSTRACT

Microfluidic fuel cell systems having two or more adjacent and parallel laminar flow streams positioned within an electrode pair assembly are disclosed herein. In one embodiment, a liquid fuel/electrolyte mixture and a liquid oxidant/electrolyte mixture are interposed between an anode structure and a cathode structure such that the liquid fuel/electrolyte mixture defines a first laminar flow stream that runs adjacent to the anode structure and the liquid oxidant/electrolyte mixture defines a second laminar flow stream that runs adjacent to the cathode structure. The anode structure may in some embodiments be derived from a first substantially planar substrate that is processed so as to have one or more discrete anodic porous regions, where each region is adapted to flow a first liquid there-through. Similarly, the cathode structure may in some embodiments be derived from a first substantially planar substrate that is also processed so as to have one or more discrete cathodic porous regions, where each region is adapted to flow a second liquid there-through. In still further embodiments, a third laminar flow stream that comprises a liquid electrolyte mixture flows in between the first and second laminar flow streams.

### TECHNICAL FIELD

The present invention is directed to fuel cell systems having internal multistream laminar flow and, more specifically, to microfluidic fuel cell systems having two or more adjacent and parallel laminar flow streams positioned within an electrode pair assembly.

### BACKGROUND OF THE INVENTION

A fuel cell is an energy conversion device that consists essentially of two opposing electrodes, an anode and a cathode, ionically connected together via an interposing electrolyte. Unlike a battery, fuel cell reactants are supplied externally rather than internally. Fuel cells operate by converting fuels, such as hydrogen or a hydrocarbon (e.g., methanol), to electrical power through an electrochemical process rather than combustion. It does so by harnessing the electrons released from controlled oxidation-reduction reactions occurring on the surface of a catalyst. A fuel cell can produce electricity continuously so long as fuel and oxidant are supplied from an outside source.

In electrochemical fuel cells employing methanol as the fuel supplied to the anode (also commonly referred to as a “Direct Methanol Fuel Cell (DMFC)” system), the electrochemical reactions are essentially as follows: first, a methanol molecule's carbon-hydrogen, and oxygen-hydrogen bonds are broken to generate electrons and protons; simultaneously, a water molecule's oxygen-hydrogen bond is also broken to generate an additional electron and proton. The carbon from the methanol and the oxygen from the water combine to form carbon dioxide. Oxygen from air (supplied to the cathode) is likewise simultaneously reduced at the cathode. The ions (protons) formed at the anode migrate through the interposing electrolyte and combine with the oxygen at the cathode to form water. From a molecular perspective, the electrochemical reactions occurring within a direct methanol fuel cell (DMFC) system are as follows:

$$\begin{matrix}Anode \text{:} \begin{matrix} {CH}_{3} OH + {H}_{2} O \to 6 {H}^{+} + 6 {e}^{-} + {CO}_{2} & {E}_{0} = 0.04 V & vs . & NHE\end{matrix} & ( 1 ) \\ Cathode \text{:} \begin{matrix}\frac{3}{2} {O}_{2} + 6 {H}^{+} + 6 {e}^{-} \to 3 {H}_{2} O & {E}_{0} = 1.23 V & vs . & NHE\end{matrix} & ( 2 ) \\ Net \text{:} \begin{matrix} {CH}_{3} OH + \frac{3}{2} {O}_{2} \to 2 {H}_{2} O + {CO}_{2} & {E}_{0} = 1.24 V & vs . & NHE\end{matrix} & ( 3 )\end{matrix}$$

The various electrochemical reactions associated with other state-of-the-art fuel cell systems (e.g., hydrogen or carbonaceous fuel) are likewise well known to those skilled in the art of fuel cell technologies.

With respect to state-of-the-art fuel cell systems generally, several different configurations and structures have been contemplated—most of which are still undergoing further research and development. In this regard, existing fuel cell systems are typically classified based on one or more criteria, such as, for example: (1) the type of fuel and/or oxidant used by the system, (2) the type of electrolyte used in the electrode stack assembly, (3) the steady-state operating temperature of the electrode stack assembly, (4) whether the fuel is processed outside (external reforming) or inside (internal reforming) the electrode stack assembly, and (5) whether the reactants are fed to the cells by internal manifolds (direct feed) or external manifolds (indirect feed). In general, however, it is perhaps most customary to classify existing fuel cell systems by the type of electrolyte (i.e., ion conducting media) employed within the electrode stack assembly. Accordingly, most state-of-the-art fuel cell systems have been classified into one of the following known groups:

1. Alkaline fuel cells (e.g., KOH electrolyte);

2. Acid fuel cells (e.g., phosphoric acid electrolyte);

3. Molten carbonate fuel cells (e.g., Li₂CO₃/K₂CO₃ electrolyte);

4. Solid oxide fuel cells (e.g., yttria-stabilized zirconia electrolyte);

5. Proton exchange membrane fuel cells (e.g., NAFION electrolyte).

Although these state-of-the-art fuel cell systems are known to have many diverse structural and operational characteristics, such systems nevertheless share many common fuel and oxidant flow stream and path characteristics. Unfortunately, existing state-of-the-art fuel and oxidant flow regimes are not entirely satisfactory for the production of small-scale portable direct feed fuel cell systems, especially in view of problems associated with reactant (e.g., methanol) “cross-over.” Accordingly, there is still a need in the art for new and improved fuel cell systems (including related sub-components and methods) that have, among other things, improved fuel and oxidant flow regimes to thereby enable better utilization of the fuel cell system's supply of reactants (i.e., fuel and oxidants). The present invention fulfills these needs and provides for further related advantages.

### SUMMARY OF THE INVENTION

In brief, the present invention is directed to fuel cell systems having multistream laminar flow and, more specifically, to microfluidic fuel cell systems having two or more laminar flow streams positioned within an electrode pair assembly. In one embodiment, the present invention is directed to an electrode pair assembly adapted for use with a fuel cell system, comprising: an anode structure; a liquid fuel/electrolyte mixture; a liquid oxidant/electrolyte mixture; and a cathode structure; wherein the anode structure and the cathode structure are spaced apart and substantially parallel to each other so as to define a spaced apart region, and wherein the liquid fuel/electrolyte mixture and the liquid oxidant/electrolyte mixture are interposed between the anode structure and the cathode structure, and wherein the liquid fuel/electrolyte mixture defines a first laminar flow stream that runs adjacent to the anode structure and the liquid oxidant/electrolyte mixture defines a second laminar flow stream that runs adjacent to the cathode structure.

In another embodiment, the present invention is directed to an electrode pair assembly adapted for use with a fuel cell system, comprising: an anode structure derived from a first substantially planar substrate, wherein the anode structure has one or more discrete anodic porous regions, wherein each of the one or more discrete anodic porous regions is adapted to flow a first liquid through the anode structure; a liquid fuel/electrolyte flow stream; a cathode structure derived from a second substantially planar substrate, wherein the cathode structure has one or more discrete cathodic porous regions, wherein each of the one or more discrete cathodic porous regions is adapted to flow a second liquid through the cathode structure; and a liquid oxidant/electrolyte flow stream; wherein the anode structure and the cathode structure are spaced apart and substantially parallel to each other so as to define a spaced apart region, and wherein a first portion of the liquid fuel/electrolyte flow stream is within the one or more discrete anodic porous regions and a second portion of the liquid fuel/electrolyte flow stream flows laminarly and adjacent to the anode structure and within the spaced apart region, and wherein a first portion of the liquid oxidant/electrolyte flow stream is within the one or more discrete cathodic porous regions and a second portion of the liquid oxidant/electrolyte flow stream flows laminarly and adjacent to the cathode structure within the spaced apart region.

These and other aspects of the present invention will become more evident upon reference to the following detailed description and attached drawings. It is to be understood, however, that various changes, alterations, and substitutions may be made to the specific fuel cell systems (including related sub-components and methods) disclosed herein without departing from their essential spirit and scope. In addition, it is to be further understood that the drawings are intended to be illustrative and symbolic representations of exemplary embodiments of the inventions disclosed herein (hence, they are not necessarily to scale). Finally, it is expressly provided that all of the various references cited herein are incorporated herein by reference in their entireties.

### BRIEF DESCRIPTION OF THE DRAWINGS

FIG. 1 illustrates a fuel cell systems in accordance with the prior art.

FIG. 2 illustrates an electrode pair assembly having a Y-shaped channel adapted for use with a fuel cell system, wherein the Y-shaped channel allows for two laminar flow streams to be selectively positioned within a spaced apart region of the electrode pair assembly.

FIG. 3 illustrates an electrode pair assembly having a Ψ-shaped channel adapted for use with a fuel cell system, wherein the Ψ-shaped channel allows for three laminar flow streams to be selectively positioned within a spaced apart region of the electrode pair assembly.

FIGS. 4A-B illustrate an electrode pair assembly having a Y-shaped channel adapted for use with a fuel cell system having flow-through electrodes, wherein the Y-shaped channel allows for two laminar flow streams to be selectively positioned within a spaced apart region of the electrode pair assembly. (Note: the underlying structures depicted by FIGS. 4A-B are essentially the same; the difference resides in the orientation of the angle of the pores and in the resulting direction that the liquid streams flow through the electrode structures.)

### DETAILED DESCRIPTION OF THE INVENTION

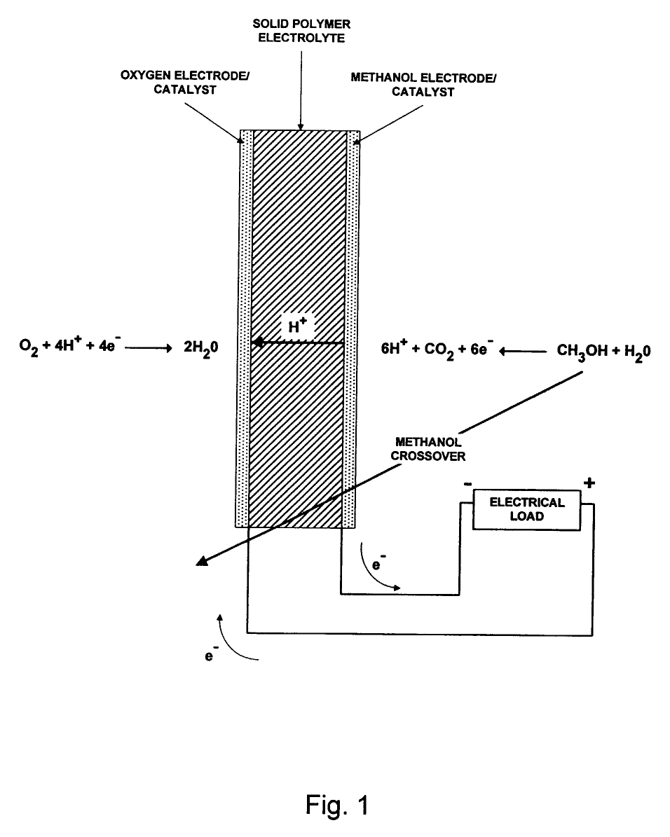

The present invention is directed to fuel cell systems having multistream laminar flow and, more specifically, to microfluidic fuel cell systems having two or more laminar flow streams positioned within an electrode pair assembly. As is appreciated by those skilled in the fuel cell technology art, a fuel cell system generally comprises a stack of electrode pair assemblies (commonly referred to as a fuel cell electrode stack assembly), wherein each individual electrode pair assembly consists essentially of two opposing electrode structures, an anode and a cathode, ionically connected together via an interposing electrolyte. The interposing electrolyte of most conventional direct fuel cell systems (e.g., direct methanol fuel cell (DMFC) systems) generally consists of a solid polymer membrane. Electrode pair assemblies having a solid polymer electrolyte (SPE) membrane are commonly referred to as membrane electrode assemblies (MEAs). A fuel cell system having a MEA in accordance with the prior art is shown in FIG. 1 (certain details have been omitted).

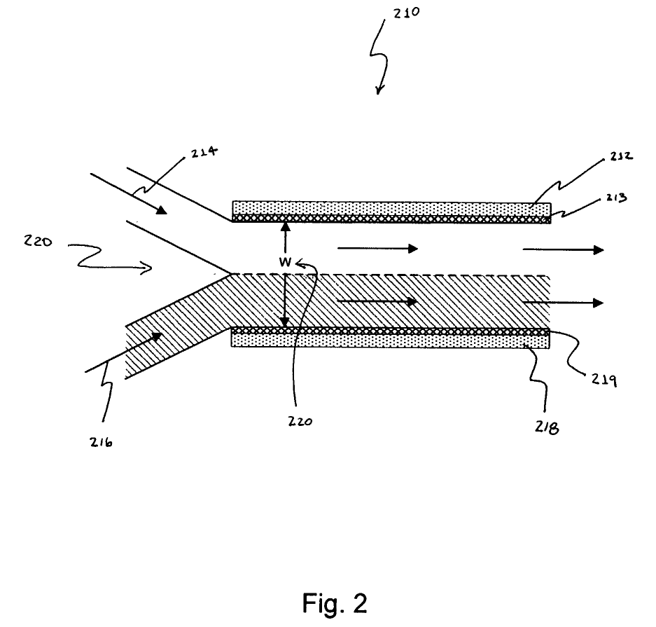

Unlike conventional MEAs known in the prior art, the present invention (in one embodiment and as shown in FIG. 2) is directed to an electrode pair assembly 210 having two (or more) internal laminar flow streams. The inventive electrode pair assembly 210 is adapted for use with a fuel cell system (not shown), wherein the electrode pair assembly 210 comprises: an anode structure 212 having a first catalyst thereon 213; a liquid fuel/electrolyte mixture 214; a liquid oxidant/electrolyte mixture 216; and a cathode structure 218 having a second catalyst thereon 219. As shown, the anode structure 212 and the cathode structure 218 are preferably spaced apart and substantially parallel to each other so as to define a spaced apart region 220 (having a selected width, w) such that (i) the liquid fuel/electrolyte mixture 214 and the liquid oxidant/electrolyte mixture 216 are generally interposed between the anode structure 212 and the cathode structure 218, and (ii) the first catalyst 213 on the anode structure 212 opposes the second catalyst 219 on the cathode structure 218. In addition, the liquid fuel/electrolyte mixture 214 generally defines a first laminar flow stream that runs adjacent to the anode structure 212, and the liquid oxidant/electrolyte mixture 216 generally defines a second laminar flow stream that runs adjacent to the cathode structure 218.

As is also shown in FIG. 2, the microfluidic fuel cell system of this embodiment of the present invention includes a Y-shaped channel 220. (Note: in alternative embodiments the Y-shaped channel is replaced by a T-shaped channel.) The Y-shaped channel 220 allows the liquid fuel/electrolyte mixture 214 and the liquid oxidant/electrolyte mixture 216 to merge and continue to flow laminarly and in parallel between the opposing channel walls of the anode structure 212 and the cathode structure 214. In this way, the two liquid laminar flow streams are in diffusive contact with each other thereby allowing for H⁺ ions to diffuse across the channel (i.e., diffuse from the first catalyst 213 on the anode structure 212 to the second catalyst 219 on the cathode structure 218).

Exemplary fuels that comprise the liquid fuel/electrolyte mixture include solutions of an alcohol such as, for example, methanol, ethanol, propanol, or combinations thereof. In addition, exemplary electrolytes that comprise the liquid fuel/electrolyte mixture and the liquid oxidant/electrolyte mixture include acids such as, for example, phosphoric acid, sulfuric acid, trifluoromethane sulfonic acid, difluoromethane diphosphoric acid, diflouromethane disulfonic acid, trifluoroacetic acid, or combinations thereof. Finally, exemplary oxidants that comprise the liquid oxidant/electrolyte mixture include oxygen, hydrogen peroxide, or a combination thereof. In some embodiments, the liquid fuel/electrolyte mixture comprises equal molar amounts of methanol and water together with an acid in an amount of about 0.01 to 3.0 M, and preferably in an amount of about 0.25 M.

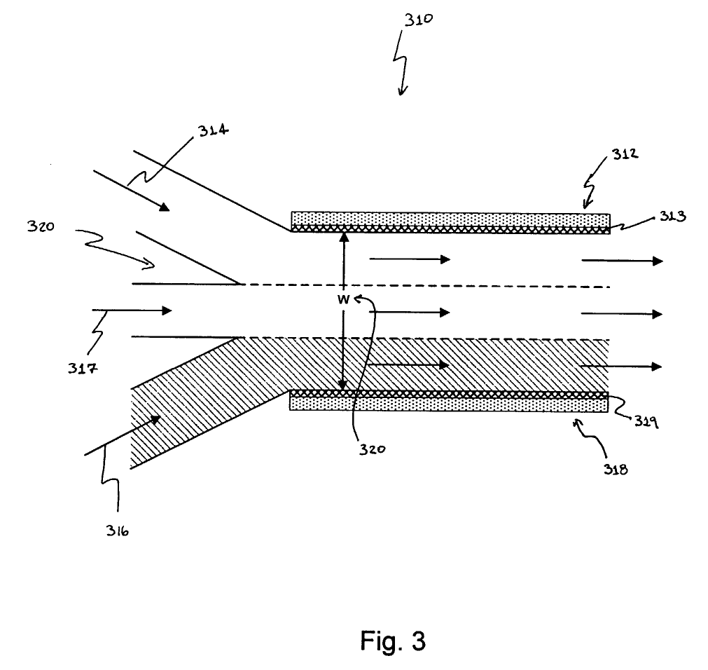

In another embodiment and as shown in FIG. 3, the present invention is directed to an electrode pair assembly 310 adapted for use with a fuel cell system (not shown), wherein the electrode pair assembly 310 comprises: an anode structure 312 having a first catalyst thereon 313; a liquid fuel/electrolyte mixture 314; a liquid oxidant/electrolyte mixture 316; a liquid electrolyte mixture 317; and a cathode structure 318 having a second catalyst thereon 319. As shown, the anode structure 312 and the cathode structure 318 are preferably spaced apart and substantially parallel to each other so as to define a spaced apart region 320 (having a selected width, w) such that (i) the liquid fuel/electrolyte mixture 314, the liquid oxidant/electrolyte mixture 316, and the liquid electrolyte mixture 317 are generally interposed between the anode structure 312 and the cathode structure 318, and (ii) the first catalyst 313 on the anode structure 312 opposes the second catalyst 319 on the cathode structure 318. In addition, the liquid fuel/electrolyte mixture 314 generally defines a first laminar flow stream that runs adjacent to the anode structure 312, the liquid oxidant/electrolyte mixture 316 generally defines a second laminar flow stream that runs adjacent to the cathode structure 318, and the liquid electrolyte mixture 317 defines a third laminar flow stream that runs adjacent and between the first and second laminar flow streams.

As is also shown in FIG. 3, the microfluidic fuel cell system of this embodiment of the present invention includes a Ψ-shaped channel 320. The Ψ-shaped channel 320 allows the liquid fuel/electrolyte mixture 314, the liquid oxidant/electrolyte mixture 316, and the liquid electrolyte mixture 317 to merge and continue to flow laminarly and in parallel between the opposing channel walls of the anode structure 312 and the cathode structure 314. In this way, the three liquid laminar flow streams are in diffusive contact with each other thereby allowing for H⁺ ions to diffuse across the channel (i.e., diffuse from the first catalyst 313 on the anode structure 312 to the second catalyst 319 on the cathode structure 318).

The dimensions of the electrode pair assembly illustrated in FIGS. 2 and 3 are such that the fluid flow is characterized by a low Reynolds number (i.e., Re<˜2,000). As used herein, the Reynolds number (Re) characterizes the tendency of a flowing liquid phase to develop turbulence, and may be expressed by the following Equation (1):

Re=Vdρ/μ (1)

where V is the average linear flow rate (m/s), d is the diameter of the “pipe” (m), ρ is the density of the fluid (kg/m³), and μ is the absolute viscosity of the fluid (Ns/m²). In the context of a flow cell or region having a rectangular cross section, the pipe diameter is more appropriately replaced with the hydraulic diameter (Dₕ), which is given by four times the cross sectional area divided by the perimeter of the flow cell or region (i.e., Dₕ=2wh/(w+h) where w and h are the width and height, respectively, of the flow cell or region). Thus, the Reynolds number of a flow cell or region having a rectangular cross section may more accurately be represented by Equation (2):

Re=VDₕρ/μ (2)

In view of the foregoing, it is apparent that the lower the velocity (ν) of the liquid flow, the diameter of the pipe or capillary (d), and the density of the liquid (ρ), and the higher the viscosity (μ) of the liquid, the lower the Reynolds number. As is appreciated by those skilled in the art, laminar flow generally occurs in fluidic systems with Re<˜2,000, and turbulent flow generally occurs in fluidic systems with Re>˜2,000 (see, e.g., P. Kenis et al., Microfabrication Inside Capillaries Using Multiphase Laminar Flow Patterning, Science 285:83-85, 1999). Thus, typical channel widths and heights associated with the microfluidic flow cells or regions (e.g., the spaced apart region between the anode structure and the cathode structure and related inlets/outlets) of the present invention range from about 10 to about 10,000 μm, preferably from about 50 to about 5,000 μm, and even more preferably from about 100 to about 1,000 μm. In addition, typical Reynolds numbers associated with the internal laminar flow streams of the present invention are generally less than 1,000, and preferably between 10 and 100.

The Y- and Ψ-shaped microfluidic channels of the present invention may be fabricated following a rapid prototyping methodology based on replica molding (see, e.g., Y. Xia and G. M. Whiteside, Chem. Int. Ed 37:550-575 (1998)). First, a master of the Y- or Ψ-shaped channel system may be made with selected dimensions in photoresist by photolithography, using a high-resolution transparency film as the mask. Second, the negative-relief master may be replicated by molding in an elastomer rubber, such as polydimethylsiloxane (PDMS). The resulting PDMS mold may then be replicated, again via molding, into a chemical resistant material membrane. The resulting membrane forms the centerpiece of the microfluidic system as it defines the dimensions of the Y- or Ψ-shaped channel. A metallic seed layer may then be applied to the sidewalls of the channel system carved out in the chemically resistant membrane by evaporative deposition. Then the catalytic layer may be applied on the metallic seed layers by chemical or atomic layer deposition (see discussion below). Finally, the membrane (now carrying the two electrodes) may be clamped between two sheets of rubber to form the top and bottom walls of the microfluidic channel system. Precise and selective control over fluid flow through the microfluidic channel system may then be achieved by use of microsyringes (connected to the microfluidic inlets and outlets via polyethylene tubing).

In the context of the present invention, exemplary electrode structures and related assemblies useful as components of the inventive electrode pair assemblies disclosed herein have been described in commonly owned PCT International Application No. PCT/US02/12386, filed Apr. 19, 2002, and entitled “Porous Silicon and Sol-Gel Derived Electrode Structures And Assemblies Adapted For Use With Fuel Cell Systems,” which application is incorporated herein by reference in its entirety. Such exemplary electrode structures are particularly useful in direct methanol circulating electrolyte fuel cell systems. In such systems, the first and second substantially planar substrates are preferably derived from a non-carbonaceous material such as, for example, Raney nickel or one or more silicon wafers. In addition, the anode structure and the cathode structure of such systems may each have a thickness ranging from about 100 to about 2,000 microns, preferably from about 200 to about 1,000 microns, and more preferably from about 300 to about 500 microns. Moreover, each anode structure may further comprise one or more discrete anodic porous regions that is defined by an array of parallel anodic acicular pores (average diameters ranging from about 0.5 to about 10 microns) that extend through the anode structure. The array of parallel anodic acicular pores may perpendicularly aligned with respect to the anode structure, or angled with respect the anode structure. Similarly, each cathode structure may further comprise one or more discrete cathodic porous regions that is defined by an array of parallel cathodic acicular pores (average diameters ranging from about 0.5 to about 10 microns) that extend through the cathode structure. The array of parallel cathodic acicular pores may be perpendicularly aligned with respect to the cathode structure, or angled with respect the cathode structure.

In addition to the foregoing, the exemplary electrode structures useful as components of the inventive electrode pair assemblies disclosed herein may further include a conformal electrically conductive layer on at least one of the inner anodic pore surfaces or inner cathodic pore surfaces. More specifically, the conformal electrically conductive layer may be selectively deposited on the one or more pore surfaces of a selected substrate (i.e., porous silicon and/or sol-gel derived support structure) by use of a sequential gas phase deposition technique such as, for example, atomic layer deposition (ALD) or atomic layer epitaxy (ALE). As with more traditional chemical vapor deposition (CVD) techniques, the reactants or precursors used with a sequential atomic deposition technique are introduced into a deposition or reaction chamber as gases. Unlike CVD, however, the reactants or precursors used are supplied in pulses, separated from each other (in the flow stream) by an intervening purge gas. Each reactant pulse chemically reacts with the substrate; and it is the chemical reactions between the reactants and the surface that makes sequential atomic deposition a self-limiting process that is inherently capable of achieving precise monolayer growth (see, e.g., Atomic Layer Deposition, T. Suntola and M. Simpson, Eds., Blackie and Sons (1990)).

In this regard, solid thin films may be grown on heated substrates by exposing the heated substrate to a first evaporated gaseous element or compound, allowing a monolayer of the element to form on the surface of the substrate, and then removing the excess gas by evacuating the chamber with a vacuum pump (or by use of a purge gas such as Argon or Nitrogen). Next, a second evaporated gaseous element or compound may be introduced into the reaction chamber. The first and second elements/compounds can then combine to produce a solid thin compound monolayer film. Once the monolayer film has been formed, any excess second evaporated gaseous element or compound may be removed by again evacuating the chamber with the vacuum pump. The desired film thickness may be built up by repeating the process cycle many (e.g., hundreds or thousands) of times. Accordingly, such an atomic deposition technique may be used to deposit on an electrode support structure (e.g., silicon or other appropriately selected substrate) a variety of materials, including group II-VI and III-V compound semiconductors, elemental silicon, SiO₂, and various metal oxides and nitrides thereof. In some preferred embodiments, however, an atomic layer deposition (ALD) technique is used to selectively deposit on the pore surfaces of a porous silicon support structure a conformal electrically conductive layer that consists essentially of a first tungsten or ruthenium layer (about 2,000 Å thick) together with a second platinum layer (about 100 Å thick). The conformal electrically conductive layer enhances electrical conductivity (between the electrons released on the catalyst as a result of electrochemical oxidation-reduction reactions), and also functions as a catalyst.

In further embodiments, the conformal electrically conductive layer may have deposited thereon a plurality of catalysts particles such as, for example, bimetallic particles of platinum and ruthenium (i.e., chemisorbed bimetallic catalysts particles derived from platinum and ruthenium precursors). Thus, a noncontiguous bimetallic layer of platinum and ruthenium may be chemisorbed on the exposed surfaces of the conformal electrically conductive layer by selective use of platinum and ruthenium precursors. For example, a conformally coated porous silicon substrate may be immersed, under basic conditions (pH 8.5), into an aqueous ammonia solution of tetraamineplatinum(II) hydroxide hydrate, [Pt(NH₃)₄](OH)₂-xH₂O, and stirred for a selected period of time. The various precursors listed above are generally available from Strem Chemicals, Inc., Newburyport, Me.

In addition to such wet chemical techniques, noncontiguous layers may also be formed by the above described sequential atomic deposition techniques, wherein such layers comprise either islands of nanocrystallites or an interconnected network of nanocrystallites. In this regard, island formation may be controlled to some degree by increasing or decreasing the number of bonding sites on the surface of the underlying substrate or support structure. For example, metal concentration on the surface may be decreased by reducing the number of bonding sites by either dehydroxylation (heat treatment) or chemical blocking of the bonding sites with, for example, hexamethyldisilazane (HMDS) (E. Lakomaa, “Atomic Layer Epitaxy (ALE) on Porous Substrates,” J. Applied Surface Science 75:185-196 (1994)).

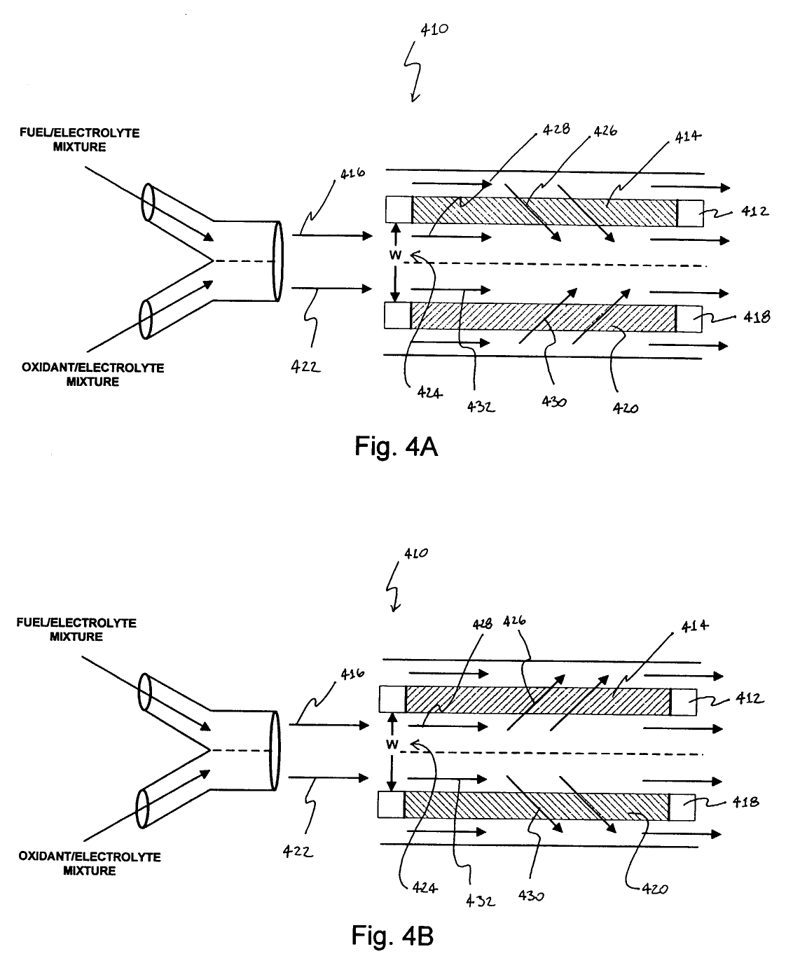

In view of the foregoing, other embodiments of the present invention (exemplary embodiments shown in FIGS. 4A-B) are directed to electrode pair assemblies having integral fuel/electrolyte and oxidant/electrolyte laminar flow streams; namely, electrode pair assemblies having flow-through electrodes adapted to flow portions of the fuel/electrolyte and fuel/oxidant laminar flow streams. Thus, and with reference to FIGS. 4A-B, another embodiment of the present invention is directed to an electrode pair assembly 410 adapted for use with a fuel cell system (not shown), comprising: (i) an anode structure 412 derived from a first substantially planar substrate, wherein the anode structure 412 has one or more discrete anodic porous regions 414, and wherein each of the one or more discrete anodic porous regions 414 is adapted to flow a first liquid through the anode structure 412; (ii) a liquid fuel/electrolyte flow stream 416; (iii) a cathode structure 418 derived from a second substantially planar substrate, wherein the cathode structure 418 has one or more discrete cathodic porous regions 420, wherein each of the one or more discrete cathodic porous regions 420 is adapted to flow a second liquid through the cathode structure 418; and (iv) a liquid oxidant/electrolyte flow stream 422. In this embodiment, the anode structure 412 and the cathode structure 418 are spaced apart and substantially parallel to each other so as to define a spaced apart region 424 (having a selected width, w). In addition, a first portion 426 of the liquid fuel/electrolyte flow stream 416 is within the one or more discrete anodic porous regions 414 and a second portion 428 of the liquid fuel/electrolyte flow stream 418 is also within the spaced apart region 424. Similarly, a first portion 430 of the liquid oxidant/electrolyte flow stream 422 is within the one or more discrete cathodic porous regions 420 and a second portion 432 of the liquid oxidant/electrolyte flow stream 422 is within the spaced apart region 424.

The electrode pair assemblies shown in FIGS. 4A-B (having integral fuel/electrolyte and oxidant/electrolyte laminar flow streams) may, in alternative embodiments, further comprise a third laminar flow stream that is positioned between the first fuel/electrolyte mixture laminar flow stream and the second oxidant/electrolyte mixture laminar flow stream. Such a third laminar flow stream generally comprises an acid, wherein the acid is phosphoric acid, sulfuric acid, trifluoromethane sulfonic acid, difluoromethane diphosphoric acid, diflouromethane disulfonic acid, trifluoroacetic acid, or a combination thereof. In further alternative embodiment, the third laminar flow stream may be replaced with a blocking layer (e.g., separator plate or membrane) such as, for example, a palladium foil or a solid polymer membrane.

While the present invention disclosed herein has been described in the context of the embodiments illustrated and described herein, the present invention may be embodied in other specific ways or in other specific forms without departing from its spirit or essential characteristics. Therefore, the described embodiments are to be considered in all respects as illustrative and not restrictive. The scope of the present invention is, therefore, indicated by the appended claims rather than by the foregoing description, and all changes that come within the meaning and range of equivalency of the claims are to be embraced within their scope.

We claim:

1. An electrode pair assembly adapted for use with a fuel cell system, comprising:
an anode structure;
a liquid fuel/electrolyte mixture;
a liquid oxidant/electrolyte mixture; and
a cathode structure;
wherein the anode structure and the cathode structure are spaced apart and substantially parallel to each other so as to define a spaced apart region, and wherein the liquid fuel/electrolyte mixture and the liquid oxidant/electrolyte mixture are interposed between the anode structure and the cathode structure, and wherein the liquid fuel/electrolyte mixture defines a first laminar flow stream that runs adjacent to the anode structure and the liquid oxidant/electrolyte mixture defines a second laminar flow stream that runs adjacent to the cathode structure.

2. The electrode pair assembly of claim 1 wherein the fuel cell system is a direct methanol circulating electrolyte fuel cell system.

3. The electrode pair assembly of claim 1 wherein the liquid fuel/electrolyte mixture comprises a fuel selected from methanol, ethanol, propanol, or a combination thereof.

4. The electrode pair assembly of claim 1 wherein the liquid oxidant/electrolyte mixture comprises an oxidant selected from oxygen, hydrogen peroxide, or a combination thereof.

5. The electrode pair assembly of claim 1 wherein the liquid fuel/electrolyte mixture or the liquid oxidant/electrolyte mixture comprises an acid selected from phosphoric acid, sulfuric acid, trifluoromethane sulfonic acid, difluoromethane diphosphoric acid, diflouromethane disulfonic acid, trifluoroacetic acid, or a combination thereof.

6. The electrode pair assembly of claim 1 wherein the anode structure is derived from a first substantially planar substrate and the cathode structure is derived from a second substantially planar substrate, and wherein the first and second substantially planar substrates are non-carbonaceous.

7. The electrode pair assembly of claim 3 wherein the first and second substantially planar substrates are silicon wafers.

8. The electrode pair assembly of claim 1 wherein the anode structure and the cathode structure each have a thickness ranging from about 300 to about 500 microns.

9. An electrode pair assembly adapted for use with a fuel cell system, comprising:
an anode structure derived from a first substantially planar substrate, wherein the anode structure has one or more discrete anodic porous regions, wherein each of the one or more discrete anodic porous regions is adapted to flow a first liquid through the anode structure;
a liquid fuel/electrolyte flow stream;
a cathode structure derived from a second substantially planar substrate, wherein the cathode structure has one or more discrete cathodic porous regions, wherein each of the one or more discrete cathodic porous regions is adapted to flow a second liquid through the cathode structure; and
a liquid oxidant/electrolyte flow stream;
wherein the anode structure and the cathode structure are spaced apart and substantially parallel to each other so as to define a spaced apart region, and wherein a first portion of the liquid fuel/electrolyte flow stream is within the one or more discrete anodic porous regions and a second portion of the liquid fuel/electrolyte flow stream flows laminarly and adjacent to the anode structure and within the spaced apart region, and wherein a first portion of the liquid oxidant/electrolyte flow stream is within the one or more discrete cathodic porous regions and a second portion of the liquid oxidant/electrolyte flow stream flows laminarly and adjacent to the cathode structure within the spaced apart region.

10. The electrode pair assembly of claim 9 wherein the fuel cell system is a direct methanol circulating electrolyte fuel cell system.

11. The electrode pair assembly of claim 9 wherein the first and second substantially planar substrates are non-carbonaceous.

12. The electrode pair assembly of claim 9 wherein the first and second substantially planar substrates are silicon wafers.

13. The electrode pair assembly of claim 9 wherein the anode structure and the cathode structure each have a thickness ranging from about 300 to about 500 microns.

14. The electrode pair assembly of claim 9 wherein each of the one or more discrete anodic porous regions is defined by an array of parallel anodic acicular pores that extend through the anode structure.

15. The electrode pair assembly of claim 9 wherein each of the one or more discrete cathodic porous regions is defined by an array of parallel cathodic acicular pores that extend through the cathode structure.

16. The electrode pair assembly of claim 14 or 15 wherein the array of parallel anodic acicular pores or the array of parallel cathodic acicular pores have diameters ranging from about 0.5 to about 10 microns.

17. The electrode pair assembly of claim 9 wherein the liquid fuel/electrolyte mixture comprises an organic fuel for reacting on the anode structure, wherein the organic fuel is ethanol, propanol, methanol, or a combination thereof.

18. The electrode pair assembly of claim 9 wherein the liquid oxidant/electrolyte mixture comprises an oxidant for reacting on the cathode structure, wherein the oxidant is oxygen, hydrogen peroxide, or a combination thereof.

19. The electrode pair assembly of claim 9 wherein the liquid fuel/electrolyte mixture or the liquid oxidant/electrolyte mixture comprises an acid selected from phosphoric acid, sulfuric acid, trifluoromethane sulfonic acid, difluoromethane diphosphoric acid, diflouromethane disulfonic acid, trifluoroacetic acid, or a combination thereof.

20. The electrode pair assembly of claim 9, further comprising a third laminar flow stream that is positioned between the first fuel/electrolyte mixture laminar flow stream and the second oxidant/electrolyte mixture laminar flow stream.
